(19) United States
(12) Patent Application Publication
(10) Pub. No.: US 2014/0044377 A1
(43) Pub. Date: Feb. 13, 2014

(54) SHOT IMAGE PROCESSING SYSTEM, SHOT IMAGE PROCESSING METHOD, MOBILE TERMINAL, AND INFORMATION PROCESSING APPARATUS

(71) Applicants: Shoji Yachida, Tokyo (JP); Daisuke Nishiwaki, Tokyo (JP); Tatsuo Akiyama, Tokyo (JP)

(72) Inventors: Shoji Yachida, Tokyo (JP); Daisuke Nishiwaki, Tokyo (JP); Tatsuo Akiyama, Tokyo (JP)

(73) Assignee: NEC CORPORATION, Tokyo (JP)

(21) Appl. No.: 14/112,525

(22) PCT Filed: Mar. 7, 2012
(86) PCT No.: PCT/JP2012/001573

§ 371 Date: Oct. 17, 2013

(30) Foreign Application Priority Data
Apr. 19, 2011 (JP) 2011-093237

(51) Int. Cl. G06T 7/00

(52) U.S. Cl. CPC G06T 7/00
USPC 382/276

(57) ABSTRACT

A shot image processing system (100) includes a mobile terminal (1) that shoots an image of a conversion target region containing a character and/or an image, and displays the shot image containing the conversion target region on a display unit; a server that receives the shot image from the mobile terminal (1), wherein the server (2) determines a specifying method for specifying a location of the conversion target region in the received shot image, and transmits the determined specifying method to the mobile terminal, and the mobile terminal (1) specifies the location of the conversion target region in the shot image based on the specifying method received from the server (2), converts the conversion target region specified in the shot image into a prescribed format, and displays a converted image obtained by the conversion on the display unit (16).

### TECHNICAL FIELD

The present invention relates to a shot image processing system, a shot image processing method, a mobile terminal, an information processing apparatus, and a control program. In particular, the present invention relates to a shot image processing system, a shot image processing method, a mobile terminal, an information processing apparatus, and a control program for allowing character information, out of an image including a region containing the character information (e.g., a signboard, a map and the like) being shot using a mobile terminal having an image shooting function or the like, to undergo translation or the like, to be displayed on a display unit of the mobile terminal.

### BACKGROUND ART

In recent years, in accordance with an increase in the number of tourists, a poster or a signboard often bears descriptions in a multitude of languages as being arranged side by side. However, such a description arrangement may appear contrarily confusing. Further, a menu of a restaurant or the like similarly bears a list written in a plurality of languages as being arranged side by side. This may also result in a confusing menu appearance. In addition, despite preparation of a multi-language menu, one may find no menu written in their own mother tongue because the number of languages that can be prepared is limited.

Further, in recent years, sophisticated camera-equipped mobile phones, camera-equipped smartphones or digital cameras are coming into use. This makes it possible for people to carry such a terminal with a sophisticated image shooting function on a daily basis. Accordingly, it is becoming easier to use various image processing techniques, e.g., recognizing characters in an image input from a camera, or extracting feature points in an image, on a daily basis. Hence, both at home and abroad, there are increasing demands for the function capable of translating any descriptions in an image of a poster or a signboard being shot by a mobile terminal or the like.

Here, Patent Literature 1 discloses a technique relating to a camera-equipped mobile terminal. The mobile terminal according to Patent Literature 1 extracts a character string by an internal OCR (Optical Character Recognition) function from image data shot by a camera, translates the character string as input information, and displays the translation result thereof. Then, when further detailed information is required, the mobile terminal connects to the Internet to make it possible to display additional information for the character string.

Further, Patent Literature 2 discloses a document link information acquisition system, in which part of a document is shot by an image shooting function of a camera-equipped mobile information terminal; where in the document a character string contained in the shot image is located is specified; and link information such as a URL associated with the location is acquired.

Still further, Patent Literature 3 discloses a document information retrieval system, in which an image of part of a document is shot by a mobile information terminal with a built-in camera; where in the document a character string contained in the shot image is located is specified; and information associated with the location is acquired. Further, what is disclosed as another object of the invention of Patent Literature 3 is a document information retrieval system, in which creation of data for specifying a location of a character is automated, and data of information associated with a document is simply created.

Still further, Patent Literature 4 discloses, as a method for obtaining, from image data containing part of a document acquired by a mobile information terminal, translation of the whole document, a system of: performing a character recognizing process to a pick-up word pattern and a word pattern surrounding the pick-up word pattern from image data of part of a shot document; specifying the whole document by extracting arrangement information of the pick-up word pattern and the surrounding word pattern; and acquiring the translation from a server, to thereby achieve translation.

Still further, Patent Literature 5 discloses an information retrieving system, which collates the feature quantity of an image of a partial region being a character region extracted from an image of a building shot by a camera-equipped mobile terminal, such that the shot building becomes less susceptible to noises, to be specified.

Patent Literature 6 discloses a technique relating to an image processing device, which extracts feature quantities such as edge features, brightness characteristics, moment features, frequency characteristics and the like from an image, to extract an object using the extracted feature quantities.

Meanwhile, Non Patent Literature 1 discloses a method for calculating SIFT feature quantities. Patent Literature 7 discloses a technique relating to a method for calculating document image feature quantities. Further, Patent Literature 8 discloses an image collating device for collating an image having been input for collating with a corresponding image out of preregistered images.

### CITATION LIST

### Patent Literatures

Patent Literature 1: Japanese Unexamined Patent Application Publication No. 2005-31827
Patent Literature 2: Japanese Unexamined Patent Application Publication No. 2006-53622
Patent Literature 3: Japanese Unexamined Patent Application Publication No. 2006-146627
Patent Literature 4: Japanese Unexamined Patent Application Publication No. 2006-048324
Patent Literature 5: Japanese Unexamined Patent Application Publication No. 2010-272054
Patent Literature 6: Japanese Unexamined Patent Application Publication No. 2007-279930
Patent Literature 7: International Patent Publication No. WO 2008/066152
Patent Literature 8: International Patent Publication No. WO 2010/053109

### Non Patent Literature

Non Patent Literature 1: D. G. Lowe, “Object Recognition from Local Scale-Invariant Features” Proc. of IEEE International Conference on Computer Vision

### SUMMARY OF INVENTION

### Technical Problem

The techniques disclosed in the above-noted Patent Literatures 1 to 6 involve problem of a heavy processing load on the mobile terminal in displaying a character string in a shot image, which has been shot using the camera-equipped mobile terminal to capture a region containing character information (such as a signboard or a map) and undergone processes such as translation. This is because the state of the shot image is influenced by various factors such as the amount and direction of light, the shooting direction of the camera and the like and, therefore, the optimum schemes for specifying the display region of the character information in a shot image cannot be unified. For example, even when the display region of the character information in a shot image can be specified by a specific scheme with the mobile terminal, that scheme may not be the optimum (low precision, longer processing time or the like) because of the state of light or the like when the identical subject is shot in another time slot. Further, the scheme of determining the optimum process based on a comparison among a plurality of processes performed every time an image is shot puts a heavy processing load on a mobile terminal. Therefore, a real-time display becomes difficult.

Firstly, according to Patent Literature 1, since the OCR function in the mobile terminal is used, a trade-off between the processing performance and the recognition performance of the mobile terminal puts a limit on the recognizable number of characters. Therefore, it is difficult to recognize characters and display them on a screen in real time. That is, the processing load is heavy for the single mobile terminal alone to perform the OCR process, the translation process and the translation result display process, as to a shot image.

Further, according to Patent Literature 2, when an image of part of text is shot and a pick-up character is specified, the pick-up character undergoes the OCR process and simultaneously information database is searched using arrangement information on the surrounding character pattern. However, in the case where character patterns are sparse as in a tourist map, or where the environment surrounding the character varies because of various coloring, it is difficult to subject the pick-up character to the OCR process.

Still further, according to Patent Literature 3 also, with the document information retrieval system in which association information indicative of a character string extracted from the document in a file and information linked to the character string are stored, and the association information is retrieved based on the positional relationship of the character string, in the case where a character string exists in a photograph or an illustration, a focused character string may not exist around the character string. Therefore, sometimes it is difficult to retrieve the information relating to the character string desired to be retrieved.

Furthermore, according to Patent Literature 4, since the focused character data and the surrounding character data are recognized as characters and the arrangement of the character data is treated as the feature quantity, to distribute the translated character data of the entire document, such a technique is not applicable to the case where not many pieces of character information are contained, such as with an outdoor map or a guideboard, or any item in which illustrations other than characters are inserted. Further, with the image shot outdoors, even when the subject is identical, the image will appear in different shape or color depending on the external environment (the amount or direction of the sunlight), the shooting direction and the like.

Further, though Patent Literature 5 describes about enhancement of tolerance against noises such as outside shadows by specifying a building based on the features of the character information described on a signboard of the building, it is silent about analogy of the whole signboard from the feature quantity of part of the signboard.

Next, according to Patent Literature 6, though it is capable of extracting an object from an image using image feature quantities, it is not verified that the image feature quantities can be calculated stably when the state of the shot image varies because of the external environment. The state of an image shot outdoors varies depending on the state of the image, such as the external environment, and the performance of the mobile terminal. Accordingly, one calculation method may be optimum at some time point, but it may turn out to be inefficient calculation method depending on the variations of the state.

The present invention is made in consideration of the problems described above, and an object of the present invention is to provide a shot image processing system, a shot image processing method, a mobile terminal, an information processing apparatus, and a control program, each for reducing the processing load on a mobile terminal while displaying an image having undergone a prescribed conversion more quickly, in causing the mobile terminal to display a shot image of a region containing characters and the like having undergone a prescribed conversion.

### Solution to Problem

A first exemplary aspect of the present invention is a shot image processing system including:

a mobile terminal that shoots an image of a conversion target region containing a character and/or an image, and displays the shot image containing the conversion target region on display unit; and

a server that receives the shot image from the mobile terminal, wherein

the server determines a specifying method for specifying a location of the conversion target region in the received shot image, and transmits the determined specifying method to the mobile terminal, and

the mobile terminal specifies the location of the conversion target region in the shot image based on the specifying method received from the server, converts the conversion target region specified in the shot image into a prescribed format, and displays a converted image obtained by the conversion on the display unit.

A second exemplary aspect of the present invention is a shot image processing method including:

shooting an image, by a mobile terminal, of a conversion target region containing a character and/or an image;

transmitting, by the mobile terminal, the shot image containing the conversion target region to a server;

determining, by the server, a specifying method for specifying a location of the conversion target region in the received shot image;

transmitting, by the server, the determined specifying method to the mobile terminal;

specifying, by the mobile terminal, the location of the conversion target region in the shot image based on the specifying method received from the server;

converting, by the mobile terminal, the conversion target region specified in the shot image into a prescribed format; and

displaying, by the mobile terminal, a converted image obtained by the conversion on the display unit.

A third exemplary aspect of the present invention is a mobile terminal including:

image shooting unit for shooting an image of a conversion target region containing a character and/or an image;

transmission unit for transmitting the shot image containing the conversion target region to a server;

reception unit for receiving a specifying method for specifying a location of the conversion target region in the shot image from the server;

specifying unit for specifying the location of the conversion target region in the shot image based on the received the specifying method;

conversion unit for converting the conversion target region specified by the shot image into a prescribed format; and

display unit for displaying a converted image obtained by the conversion.

A forth exemplary aspect of the present invention is an information processing apparatus including:

reception unit for receiving, from a mobile terminal having shot an image of a conversion target region containing a character and/or an image, the shot image containing the conversion target region;

determining unit for determining a specifying method for specifying a location of the conversion target region in the received shot image; and

transmission unit for transmitting the determined specifying method to the mobile terminal for causing the mobile terminal to specify the location of the conversion target region in the shot image based on the determined specifying method, to convert the conversion target region specified in the shot image into a prescribed format, and to display the converted image obtained by the conversion on display means.

A fifth exemplary aspect of the present invention is a control program for causing a mobile terminal to execute:

a process of shooting an image of a conversion target region containing a character and/or an image;

a process of transmitting the shot image containing the conversion target region to a server;

a process of receiving a specifying method for specifying a location of the conversion target region in the shot image from the server;

a process of specifying the location of the conversion target region in the shot image based on the received specifying method;

a process of converting the conversion target region in the shot image into a prescribed format; and

a process of displaying a converted image obtained by conversion on display unit.

A sixth exemplary aspect of the present invention is a control program for causing a computer to perform:

a process of receiving, from a mobile terminal having shot an image of a conversion target region containing a character and/or an image, the shot image containing the conversion target region;

a process of determining a specifying method for specifying a location of the conversion target region in the received shot image; and

a process of transmitting the determined specifying method to the mobile terminal for causing for causing the mobile terminal to specify the location of the conversion target region in the shot image based on the determined specifying method, to convert the conversion target region specified in the shot image into a prescribed format, and to display the converted image obtained by the conversion on a display unit.

### Advantageous Effects of Invention

The present invention can provide a shot image processing system, a shot image processing method, a mobile terminal, an information processing apparatus, and a control program, each for, in causing a mobile terminal to display a shot image of a region containing characters and the like having undergone a prescribed conversion, displaying an image having undergone a prescribed conversion more quickly while reducing the processing load on the mobile terminal.

### BRIEF DESCRIPTION OF DRAWINGS

FIG. 1 is a block diagram showing a configuration of a shot image processing system according to a first embodiment of the present invention.

FIG. 2 is a sequence diagram showing a flow of a shot image processing method according to the first embodiment of the present invention.

FIG. 3 is a block diagram showing a configuration of a shot image processing system according to a second embodiment of the present invention.

FIG. 4 is a sequence diagram showing a flow of a shot image processing method according to the second embodiment of the present invention.

FIG. 5 is a flowchart showing a flow of a process of a server according to the second embodiment of the present invention.

FIG. 6 is a flowchart showing a flow of a process of a mobile terminal according to the second embodiment of the present invention.

FIG. 7 shows an exemplary partial translation according to the second embodiment of the present invention.

### DESCRIPTION OF EMBODIMENTS

In the following, with reference to the drawings, a detailed description will be given of specific embodiments to which the present invention is applied. In the drawings, identical reference signs are allotted to identical elements. For the sake of clarity, repetitive descriptions will be omitted as necessary.

### First Embodiment of the Invention

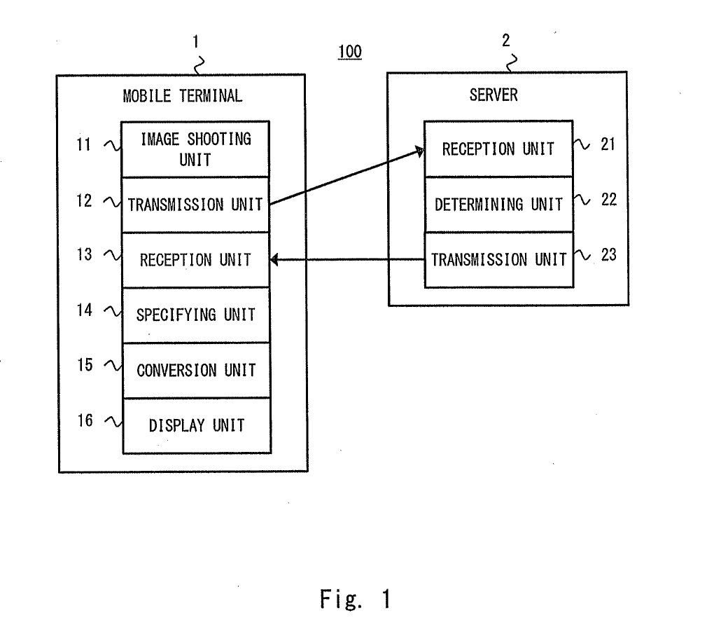

FIG. 1 is a block diagram showing the configuration of a shot image processing system 100 according to a first embodiment of the present invention. The shot image processing system 100 includes a mobile terminal 1 and a server 2.

The mobile terminal 1 is a mobile electronic device having an image shooting function. For example, the mobile terminal 1 is a camera-equipped mobile phone, a camera-equipped smartphone, a digital camera or the like. The mobile terminal 1 includes an image shooting unit 11, a transmission unit 12, a reception unit 13, a specifying unit 14, a conversion unit 15, and a display unit 16. The image shooting unit 11 is a camera or the like for shooting an image of a prescribed region. The prescribed region is a conversion target region containing characters and/or images. Further, such a prescribed region may contain any region in addition to the conversion target region. An exemplary prescribed region is a signboard, a map or the like, which contains information such as figures or symbols in addition to character information such as place-names or descriptions. It is understood that the shot image shot by the image shooting unit 11 contains the conversion target region.

The transmission unit 12 transmits the shot image containing the conversion target region to the server 2. The reception unit 13 receives, from the server 2, a specifying method for specifying the location of the conversion target region in the shot image. An exemplary specifying method may be a calculation method for calculating a feature quantity, which is an expression of a figure or the like in an image in numerical values corresponding to a plurality of properties, obtained by analysis of the shot image. The specifying method is a program module in which a processing logic of the calculation method is installed, identification information of the calculation method or the like. Note that the specifying method is not limited thereto.

The specifying unit 14 specifies the location of the conversion target region in the shot image based on the received specifying method. The conversion unit 15 converts the conversion target region specified in the shot image to a prescribed format. For example, in the case where the conversion target region contains character information, the conversion unit 15 translates the character information into a prescribed language, or generates an image in which the conversion target region is replaced by translated image data. The display unit 16 is a display device such as a screen for displaying the converted image.

The server 2 is an information processing apparatus capable of establishing communication with the mobile terminal 1. The server 2 includes a reception unit 21, a determining unit 22, and a transmission unit 23. The reception unit 21 receives a shot image from the mobile terminal 1. The determining unit 22 determines a specifying method for specifying the location of a conversion target region in the received shot image. It is understood that, in determining, the determining unit 22 selects the optimum specifying method in accordance with the state of the shot image, the function and processing capacity of the mobile terminal 1 and the like. Alternatively, the determining unit 22 may determine the optimum specifying method for a shot image, based on trial results of a plurality of shot image specifying methods.

The transmission unit 23 transmits the determined specifying method to the mobile terminal 1. That is, the transmission unit 23 transmits the determined specifying method to the mobile terminal 1, in order to cause the mobile terminal 1 to specify the location of the conversion target region in the shot image based on the determined specifying method; to convert the conversion target region specified in the shot image into a prescribed format; and to cause the display unit 16 to display the converted image.

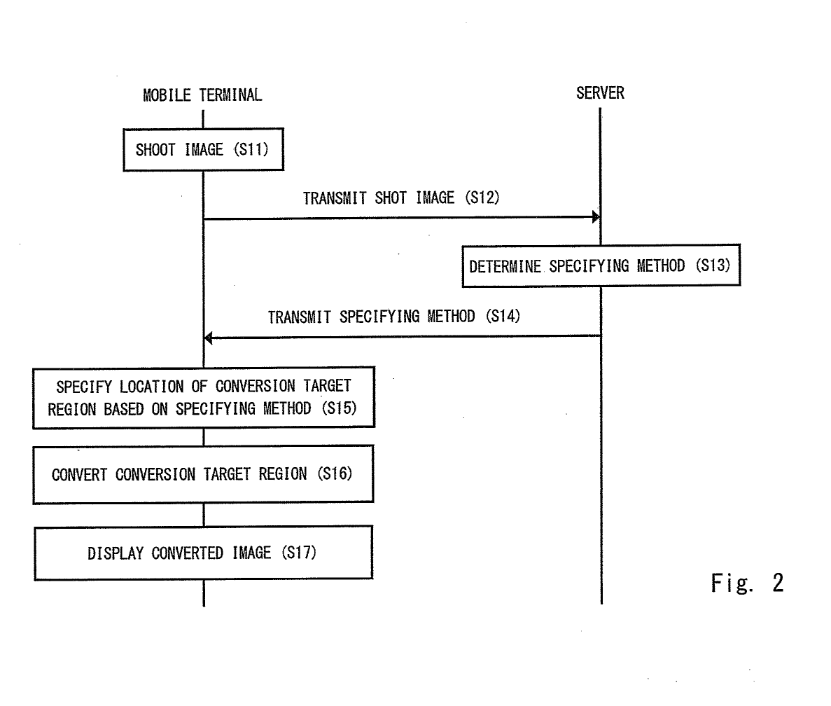

FIG. 2 is a sequence diagram showing the flow of the shot image processing method according to the first embodiment of the present invention. Firstly, the image shooting unit 11 of the mobile terminal 1 shoots an image of a region containing a conversion target region (S11). Next, the transmission unit 12 of the mobile terminal 1 transmits the shot image to the server 2 (S 12).

Subsequently, the reception unit 21 of the server 2 receives the shot image from the mobile terminal 1. Then, the determining unit 22 of the server 2 determines the specifying method for specifying the location of the conversion target region in the shot image (S13). Thereafter, the transmission unit 23 of the server 2 transmits the determined specifying method to the mobile terminal 1 (S14).

Then, the reception unit 13 of the mobile terminal 1 receives the specifying method from the server 2. Subsequently, the specifying unit 14 of the mobile terminal 1 specifies, based on the received specifying method, the location of the conversion target region in the shot image (S15). Then, the conversion unit 15 of the mobile terminal 1 converts the specified conversion target region (S 16). Thereafter, the display unit 16 of the mobile terminal 1 displays the converted image (S17).

In this manner, according to the first embodiment of the present invention, in causing the mobile terminal to display a shot image of a region containing characters and the like having undergone a prescribed conversion, the image having undergone the prescribed conversion can be displayed more quickly while the processing load of the mobile terminal is reduced.

As has been discussed in Technical Problem above, the processing load is heavy for the mobile terminal alone to determine the specifying method for specifying the conversion target region in the shot image. Hence, it takes time for an ordinary camera-equipped mobile terminal to display, after shooting an image, the converted image on the display unit 16, and a real-time display is difficult. Accordingly, with the shot image processing system 100 according to the first embodiment of the present invention, the server 2 with rich resources as compared to the mobile terminal 1 is caused to execute the process of determining the specifying method with a heavy processing load. Thus, the processing load on the mobile terminal 1 can be reduced and displaying of the converted image can be accelerated. Accordingly, shooting an image followed by displaying the converted image can be realized in real time.

### Second Embodiment of the Invention

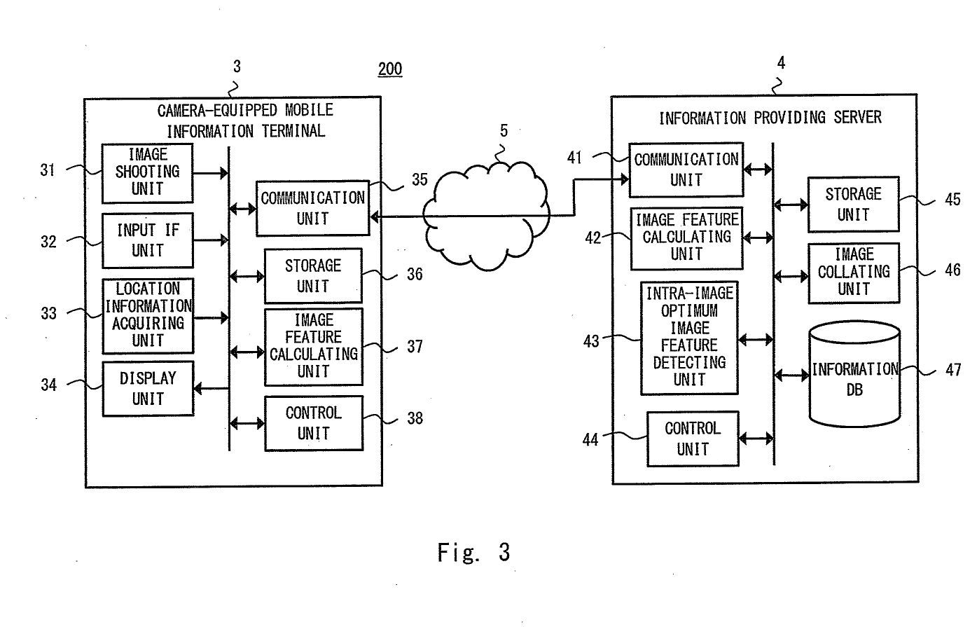

FIG. 3 is a block diagram showing a configuration of a shot image processing system 200 according to a second embodiment of the present invention. The shot image processing system 200 is one exemplary mode of the first embodiment, being an information providing system for providing information for performing translation or the like as to character information in a shot image. In the following, descriptions as to configurations similar to those in the first embodiment are omitted as appropriate.

The shot image processing system 200 includes a camera-equipped mobile information terminal 3, an information providing server 4, and a network 5. The network 5 is a communication network connecting the camera-equipped mobile information terminal 3 and the information providing server 4 to each other. The network 5 is a communication network, e.g., the Internet, an intranet, a public network, a private line, a mobile communication network and the like. Note that, the camera-equipped mobile information terminal 3 and the information providing server 4 may be directly connected to each other without any intervention of the network 5.

The camera-equipped mobile information terminal 3 is one exemplary mode of the mobile terminal 1. The camera-equipped mobile information terminal 3 includes an image shooting unit 31, an input IF unit 32, a location information acquiring unit 33, a display unit 34, a communication unit 35, a storage unit 36, an image feature calculating unit 37, and a control unit 38. The image shooting unit 31 is the equivalent of the image shooting unit 11. The image shooting unit 31 shoots an image of a partial region in the whole region of a signboard, a map or the like. It is understood that the signboard, the map or the like contains a region in which character information such as a shop name, a place-name, a description or the like appears. Note that, the region is one example of the conversion target region described above. That is, it is not necessarily for the character information to appear in the conversion target region.

The input IF unit 32 is an interface that accepts an instruction to convert a shot image from the operator of the camera-equipped mobile information terminal 3. The input IF unit 32 is the interface that accepts an input of a shot image being a conversion-target from the operator of the camera-equipped mobile information terminal 3. The input IF unit 32 may be, for example, a manipulation with a touch sensor arranged on a screen, or it may be a switch that is arranged at the position different from the screen.

The location information acquiring unit 33 acquires location information of the present location of the camera-equipped mobile information terminal 3. The location information acquiring unit 33 acquires, for example, GPS (Global Positioning System) information.

The display unit 34 is the equivalent of the display unit 16 described above. The communication unit 35 communicates with a communication unit 41 of the information providing server 4 via the network 5. The communication unit 35 transmits a shot image which is shot by the image shooting unit 31 and whose conversion is instructed by the input IF unit 32, location information acquired by the location information acquiring unit 33 and the like to the communication unit 41 via the network 5. Further, the communication unit 35 receives the specifying method, whole image information whose description will follow, a converted image and the like from the communication unit 41 via the network 5. Further, the communication unit 35 stores the received information in the storage unit 36. Note that communication between the communication unit 35 and the communication unit 41 may be performed in a wired or wireless manner. Further, any communication protocol can be applied to the communication between the communication unit 35 and the communication unit 41. The storage unit 36 is a volatile or non-volatile storage device. The storage unit 36 may be, for example, a primary storage device such as a memory, or a hard disk, a flash memory or the like.

The image feature calculating unit 37 calculates the image feature quantity from the shot image using the specifying method received from the communication unit 35. For example, the processing logic of a plurality of specifying methods are previously installed in the image feature calculating unit 37, and upon reception of a specification as to one of the plurality of specifying methods from the information providing server 4, the image feature calculating unit 37 calculates an image feature quantity based on the processing logic of the specified specifying method. Alternatively, the image feature calculating unit 37 may be capable of externally receiving a program module in which a prescribed processing logic is installed, to execute the program module. In this case, the image feature calculating unit 37 can use a specifying method by receiving a program module in which the processing logic of the specifying method determined by the information providing server 4 is installed. Note that, when whole image data itself, whose description will follow, is received from the information providing server 4, the image feature calculating unit 37 calculates the image feature quantity from the whole image data.

The control unit 38 controls various operations of the camera-equipped mobile information terminal 3. The control unit 38 is, for example, a CPU (Central Processing Unit) or the like. In particular, the control unit 38 reads information from the storage unit 36; collates the image feature quantity of the shot image calculated by the image feature calculating unit 37 with the image feature quantity of the whole image; and specifies the region where the shot image is contained in the whole image. Then, the control unit 38 performs conversion processing or the like to the specified region. The control unit 38 causes the display unit 34 to display the shot image or the converted image.

The information providing server 4 is one exemplary mode of the server 2. The information providing server 4 includes a communication unit 41, an image feature calculating unit 42, an intra-image optimum image feature detecting unit 43, a control unit 44, a storage unit 45, an image collating unit 46, and an information DB (DataBase) 47.

The communication unit 41 communicates with the communication unit 35 of the camera-equipped mobile information terminal 3 via the network 5. The communication unit 41 receives a shot image or the like from the communication unit 35 via the network 5, and stores the shot image in the storage unit 45. Further, the communication unit 41 transmits the determined specifying method or the like to the communication unit 35 via the network 5.

The information DB 47 is a database realized by a storage device that previously stores a plurality of pieces of whole image information on a plurality of whole regions. A plurality of whole regions refer to, for example, a plurality of signboards or maps in their entirety. It is understood that each of the whole regions contains a conversion target region such as characters and the like. Further, it is understood that the entire region contains, in addition to characters, information that does not require translation, such as figures, symbols and the like. It is understood that the whole image information is the image data of the whole signboard or the image feature quantity calculated according to a prescribed specifying method using that image data.

Further, it is understood that the information DB 47 further stores the location information in the whole image information on the conversion target region contained in each of pieces of whole image information. The location information is, for example, coordinates in the map of a region where a place-name or the like appears, in the case where the whole image information represents a map.

The image feature calculating unit 42 calculates the image feature quantity from the shot image received from the communication unit 41. The image feature quantity calculation method performed by the image feature calculating unit 42 may be the SIFT feature quantity disclosed in Non Patent Literature 1, the document image feature quantity disclosed in Patent Literature 7 or the like. Further, the image feature calculating unit 42 may use any existing image feature quantity such as those disclosed in Patent Literature 8. Still further, the image feature calculating unit 42 may previously calculate the image feature quantity using the whole image data, to store the image feature quantity in the information DB 47.

The image collating unit 46 collates the image feature quantity of the shot image calculated by the image feature calculating unit 42 with the image feature quantity of a plurality of pieces of whole image information stored in the information DB 47, and selects the whole image information that contains the shot image.

The intra-image optimum image feature detecting unit 43 detects, i.e., determines, from the whole image information selected by the image collating unit 46, the optimum specifying method for specifying the location of the conversion target region in the shot image. Here, the specifying method can be paraphrased into a method for calculating image feature quantity that is adequate to specify the location where the character information is contained from the image data. That is, the intra-image optimum image feature detecting unit 43 searches for a method for calculating an image feature quantity with which what location the shot image represents in the whole image can be determined with ease. Then, the intra-image optimum image feature detecting unit 43 determines the method for calculating the feature quantity of the conversion target region as the specifying method. Accordingly, the control unit 38 of the camera-equipped mobile information terminal 3 calculates the feature quantity in the shot image using the feature quantity calculation method, and specifies the location of the conversion target region in the shot image base on the calculation result.

Note that, the intra-image optimum image feature detecting unit 43 may analyze the shot image or the selected whole image data according to a plurality of specifying methods, and may determine the optimum specifying method based on comparison of collation precision. Further, the intra-image optimum image feature detecting unit 43 may determine the optimum specifying method according to the type of the selected whole image data. For example, the image feature quantity calculation method may be previously associated with intended uses, i.e., whether the whole image data is a map, a guideboard, a description board of a historic site or the like. Further, the shot image may be analyzed, such that the optimum image feature quantity calculation method can be determined depending on the state according to various factors such as the amount and direction of light, the shooting direction of the camera and the like. This is because the method for specifying the location to be focused in the whole image with the least calculation amount differs depending on images.

Further, the intra-image optimum image feature detecting unit 43 should determine the optimum specifying method according to the processing performance of the camera-equipped mobile information terminal 3 or the processing logic that can be executed. Thus, the load attributed to calculation amount on the camera-equipped mobile information terminal 3 can be minimized. Note that, when the specifying method determined by the intra-image optimum image feature detecting unit 43 is different from the specifying method used by the image feature calculating unit 42, the image feature calculating unit 42 should calculate the image feature quantity using the specifying method determined from the selected whole image. Then, when the communication unit 41 transmits the specifying method or the like to the communication unit 35, the communication unit 41 should transmit the calculated image feature quantity inclusive. Thus, collation by the camera-equipped mobile information terminal 3 can be efficiently performed.

The control unit 44 controls various operations of the information providing server 4. The control unit 44 is, for example, a CPU or the like. The storage unit 45 is a volatile or non-volatile storage device. The storage unit 36 may be a primary storage device such as a memory, a hard disk, a flash memory or the like.

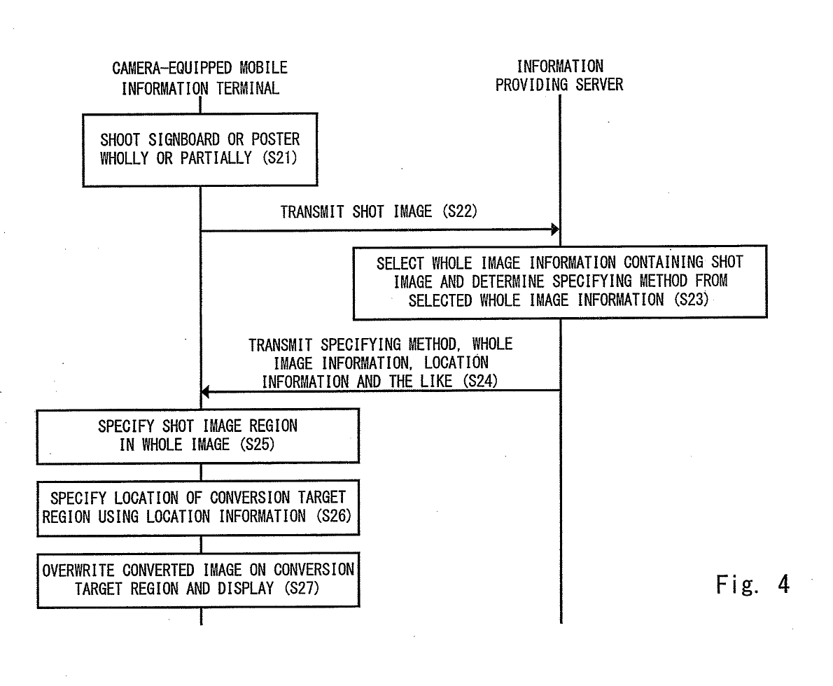

FIG. 4 is a sequence diagram showing the flow of the shot image processing method according to the second embodiment of the present invention. Firstly, the image shooting unit 31 shoots an image of the whole or part of a signboard or a poster (S21). Note that, for convenience of description, the following is predicated on the case where an image of part of a signboard or a poster is shot. For example, the operator of the camera-equipped mobile information terminal 3 shoots an image of part of the signboard or the like, checks the shot image and instructs the input IF unit 32 to translate the character information part. The input IF unit 32 transmits the shot image to the information providing server 4 via the communication unit 35 in response to the instruction from the operator (S22).

The communication unit 41 receives the shot image from the camera-equipped mobile information terminal 3 via the network 5. Then, the communication unit 41 stores the shot image in the storage unit 45. Subsequently, the image feature calculating unit 42, the image collating unit 46, and the intra-image optimum image feature detecting unit 43 select the whole image information containing the shot image, and determines a specifying method based on the selected whole image information (S23).

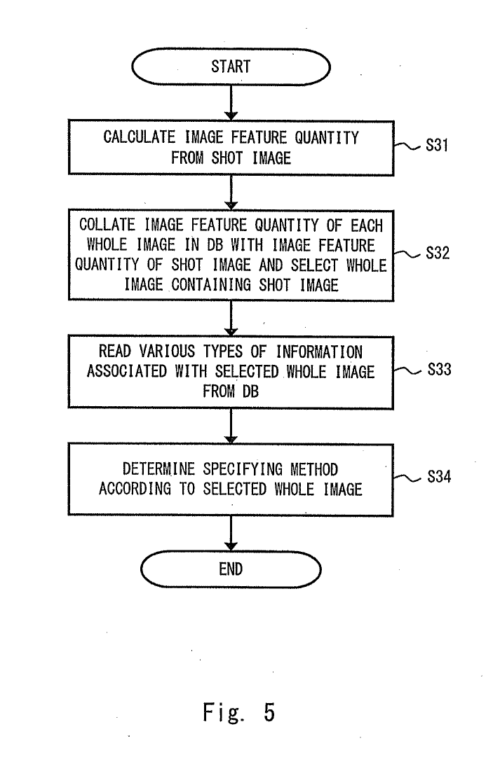

Here, with reference to FIG. 5, the processing by the information providing server 4 will be detailed. Firstly, the image feature calculating unit 42 calculates the image feature quantity from the shot image (S31). Next, the image collating unit 46 collates the whole images in the information DB 47 with the image feature quantity of the shot image, and selects the whole image that contains the shot image (S32). That is, the image collating unit 46 refers to the information DB 47, and selects the whole image information corresponding to the shot image out of a plurality of pieces of whole image information, based on the image feature quantity of the shot image calculated by the image feature calculating unit 42. Then, the image collating unit 46 reads various types of information associated with the selected whole image from the information DB 47 (S33). At this time, the image collating unit 46 reads, as various types of information, the whole image data itself, or the image feature quantity, location information or the like of the whole image. Subsequently, the intra-image optimum image feature detecting unit 43 determines the specifying method according to the selected whole image (S34).

The description will be given referring again to FIG. 4. Thereafter, the communication unit 41 transmits the specifying method, the whole image information, the location information and the like to the camera-equipped mobile information terminal 3 (S24). That is, the communication unit 41 transmits, to the camera-equipped mobile information terminal 3, the selected whole image information and the location information of the conversion target region contained in that whole image information, together with the determined specifying method. At this time, the whole image information should include the image feature quantity of the whole image calculated by the determined specifying method.

The communication unit 35 receives the specifying method, the whole image information, the location information and the like from the communication unit 41 via the network 5. At this time, the communication unit 35 stores the received specifying method, the whole image information, the location information and the like in the storage unit 36. Then, the image feature calculating unit 37 and the control unit 38 specify the region of the shot image located in the whole image, based on the specifying method stored in the storage unit 36 (S25). Subsequently, the control unit 38 specifies the position of the conversion target region using the location information contained in the region of the specified shot image (S26). Further, the display unit 34 overwrites the converted image on the conversion target region and displays the converted image (S27). In this manner, use of the location information can reduce the analysis process as to the inside of the shot image.

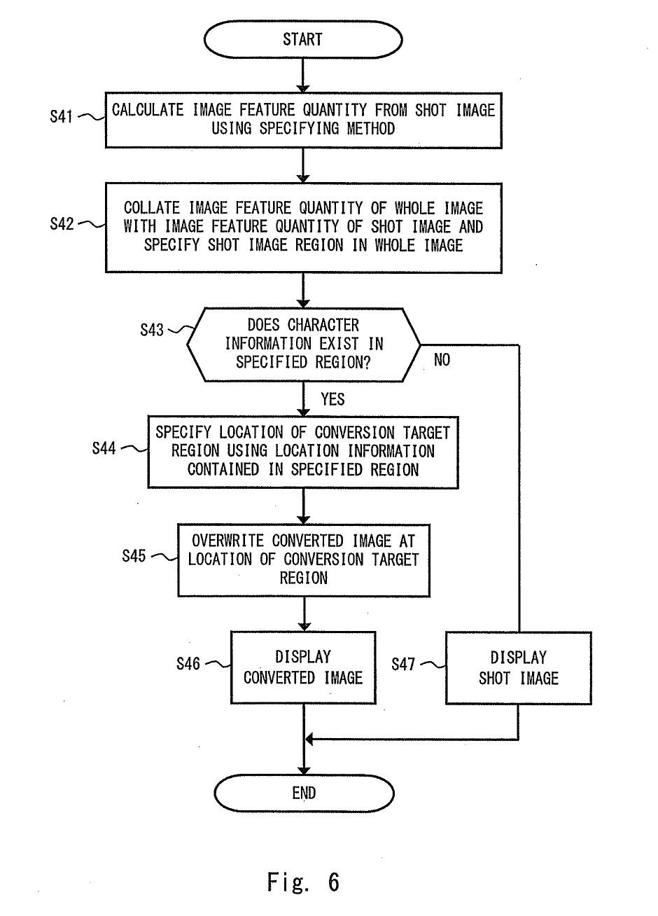

FIG. 6 is a flowchart showing the flow of the process of the camera-equipped mobile information terminal 3 according to the second embodiment of the present invention. Firstly, the image feature calculating unit 37 calculates the image feature quantity from the shot image using the received specifying method (S41). Next, the control unit 38 collates the image feature quantity of the whole image with that of the shot image, and specifies the region of the shot image located in the whole image (S42). Then, the control unit 38 determines whether or not character information exists in the specified region (S43). When it is determined that character information exists in the specified region, the control unit 38 specifies the location of the conversion target region using the location information contained in the specified region (S44). That is, the control unit 38 can specify the location of the conversion target region in the shot image, based on the conversion target region in the whole image, coordinates of the region of the shot image located in the whole image and the like. Accordingly, it becomes possible to reduce the load of the analyzing process for the shot image itself performed for specifying the location of the conversion target region.

Thereafter, the control unit 38 overwrites the converted image at the location of the conversion target region (S45). The converted image may be, for example, an image bearing a translation result that corresponds to the character string in the conversion target region and that is obtained from the information providing server 4. Note that, the control unit 38 may perform an OCR process or the like to the conversion target region instead of overwriting, and may perform translation or the like to the recognized character string. Then, the display unit 34 displays the converted image (S46).

Further, in Step S43, when it is determined that character information exists in the specified region, the control unit 38 displays the shot image without performing conversion (S47). Note that, when the shot image is already displayed, Step S47 may not be executed.

Thereafter, in the case where the operator moves the camera-equipped mobile information terminal 3 and shoots an image of other region of the map or the like, that is, when the camera-equipped mobile information terminal 3 reshoots an image of other region of the identical subject, the camera-equipped mobile information terminal 3 does not transmit the reshot image to the information providing server 4. Then, the image feature calculating unit 37 specifies the location of the conversion target region in the reshot image using the previously received specifying method stored in the storage unit 36. Further, the control unit 38 uses the previously received whole image information, the location information and the like stored in the storage unit 36. In other words, when the image feature calculating unit 37 specifies the location of the conversion target region in the reshot image, the image feature calculating unit 37 uses the specifying method being identical to the specifying method used for the shot image obtained by previously shooting the image of a partial region. That is, for example, in the case where the shooting position of the camera is shifted, by using the already received specifying method again instead of requerying the server, the second and following shot image processes can be performed efficiently.

It means that, so long as the reshot image reshot by the camera-equipped mobile information terminal 3 is within the range of the whole image stored in the storage unit 36, it is not necessary to newly communicate with the information providing server 4, and the character information is converted following the image displayed solely by the internal calculation process performed by the camera-equipped mobile information terminal 3.

Further, the information DB 47 should further store the converted image corresponding to the conversion target region contained in each of pieces of whole image information. In this case, the information providing server 4 transmits the converted image corresponding to the conversion target region contained in the selected whole image information to the camera-equipped mobile information terminal 3 together with the determined specifying method. Then, when the camera-equipped mobile information terminal 3 converts the conversion target region into a prescribed format, the camera-equipped mobile information terminal 3 uses the converted image received from the server. Thus, the processing load of the OCR process or conversion performed by the camera-equipped mobile information terminal 3 can be reduced.

Further, when the shot-target region is a tourist guide map and the characters are appearing in a language being different from the language usually used by the operator of the camera-equipped mobile information terminal 3 (i.e., the first language), such characters can be displayed as being replaced by character information in the first language. In this case, the information DB 47 stores the converted image for each of a plurality of language types. Then, the camera-equipped mobile information terminal 3 adds the language type of the operator to the shot image and transmits the language type and the shot image to the information providing server 4. Thereafter, the information providing server 4 refers to the information DB 47, and selects the converted image corresponding to the conversion target region contained in the specified whole image information, based on the received language type.

Further, the conversion of the character information is not limited to translation, for example, from Japanese to English. In the case where a grade-schooler reads a signboard bearing difficult Chinese characters, such characters can be converted into words that can be easier for the grade-schooler to understand. Alternatively, it is also possible to convert character information into an image such as a photograph or an illustration, or to display video images. In this case, the information DB 47 stores the converted image for each of a plurality of pieces of age information. Then, the camera-equipped mobile information terminal 3 adds the age information of the operator to the shot image and transmits to the information providing server 4. Thereafter, the information providing server 4 refers to the information DB 47, and selects the converted image corresponding to the conversion target region contained in the specified whole image information, based on the received age information.

Further, it is desirable to include the present location of the camera-equipped mobile information terminal 3, in transmitting a shot image from the camera-equipped mobile information terminal 3 to the information providing server 4. In this case, the information DB 47 stores location information indicative of the locations of a plurality of whole regions and the pieces of whole image information as being associated with each other. Then, the camera-equipped mobile information terminal 3 acquires the location information indicative of the location of the mobile terminal by the location information acquiring unit 33. Then, the communication unit 35 adds the acquired location information to the shot image and transmits the acquired location information and the shot image to the information providing server 4. Thereafter, the information providing server 4 refers to the information DB 47, and selects whole image information corresponding to the shot image based on the calculated feature quantity and the received location information. Thus, the image collating unit 46 becomes capable of selecting data to be read from the information DB 47 by the location information. Accordingly, the data amount processed in the information providing server 4 can be reduced, and the entire processing time can be drastically reduced.

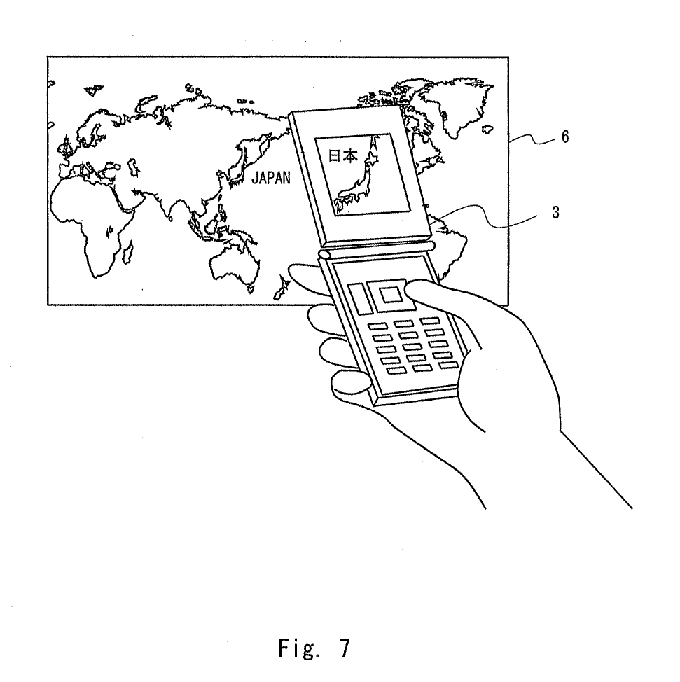

FIG. 7 shows an exemplary partial translation as an example of a use method according to the second embodiment of the present invention. The map 6 shows a world map, bearing character information such as a place-name at each place. For example, near the Japanese archipelago in the map 6, alphabetical character information “Japan” is shown, while alphabetical character information “Australia” is shown near the Australian continent. It is understood that the information DB 47 previously stores the whole image information corresponding to the map 6, pieces of location information of pieces of character information, and converted images being translations of pieces of character information into the language other than English, as being associated with one another.

Here, it is assumed that the operator shoots an image around the Japanese archipelago in the map 6 by the camera-equipped mobile information terminal 3, and instructs translation into Japanese. In this case, the shot image contains the figures around the Japanese archipelago and the notation “ [symbol] ” (nippon). Then, the shot image is transmitted to the information providing server 4.

The image feature calculating unit 42 of the information providing server 4 calculates the image feature quantity of the shot image, and the image collating unit 46 detects that the shot image is part of the map 6. That is, the map 6 is selected as the whole image information. Then, the image collating unit 46 reads the image data and image feature quantities in the map 6, the location information of each character information in the map 6 (for example, the coordinates where the notations “Japan”, “Australia” and the like appear), and the images of the character information translated into Japanese (For example, an image with notation of “ [symbol] ” (nippon), “ [symbol] ” (goshu) or the like) from the information DB 47. Also, the intra-image optimum image feature detecting unit 43 determines the optimum specifying method, that is, the method for calculating the feature quantity indicative of the inner feature of the world map, in accordance with the state of the shot image or the function of the camera-equipped mobile information terminal 3. Then, the information providing server 4 transmits the information read from the information DB 47 and the specifying method to the camera-equipped mobile information terminal 3.

The communication unit 35 of the camera-equipped mobile information terminal 3 stores the received various types of information into the storage unit 36. Then, the image feature calculating unit 37 specifies that the shot image represents the location around the Japanese archipelago in the map 6, according to the specifying method. Then, the control unit 38 determines, based on the location information, that the character information “Japan” is inscribed near the Japanese archipelago in the map 6. Accordingly, it can be recognized that the character information “Japan” is inscribed at the corresponding location in the shot image. Thereafter, the control unit 38 generates the converted image by overwriting an image bearing “ [symbol] ” (nippon) at the location where the character information “Japan” is inscribed in the shot image. Thereafter, the display unit 34 displays the converted image as shown in FIG. 7.

Further thereafter, it is assumed that the operator shifts the camera-equipped mobile information terminal 3 and shoots an image around the Australian continent in the map 6 and instructs translation into Japanese. In this case, the camera-equipped mobile information terminal 3 does not transmit the shot image to the information providing server 4, and the image feature calculating unit 37 calculates the image feature quantity from the shape of the Australian continent or the reshot image with an inscription “Australia”. Then, the control unit 38 specifies the region of the reshot image in the map 6 using the image feature quantity in the map 6 previously stored in the storage unit 36, and creates a converted image by overwriting “ [symbol] ” (goshu) at the location where the character information “Australia” is inscribed in the shot image. Then, the converted image is displayed on the display unit 34.

Therefore, the camera-equipped mobile information terminal 3 can display the translation result, in the case of reshooting, solely by the internal process according to the determined specifying method. At this time, since the camera-equipped mobile information terminal 3 is only required to perform the processes of Steps S25 to S27 in FIG. 4 to the reshot image, the operator feels that partial translation is performed substantially in real time.

### Other Embodiment of the Invention

As has been described above, according to the first and second embodiments of the present invention, it becomes possible to convert a tourist guideboard or a shop menu into any other language or to process them to be legible, and to display the result.

Further, according to the first and second embodiments of the present invention, the determined specifying method may not be necessarily transmitted from the server to the mobile terminal. For example, in the server, the location of the conversion target region in the shot image may be specified based on the determined specifying method, and the specified location information may be transmitted to the mobile terminal. Further, in the server, the conversion target region may be converted into a prescribed format, and the converted image may be sent to the mobile terminal.

Further, an information providing method according to other embodiment of the present invention includes: camera-equipped mobile terminal means, the camera-equipped mobile terminal means including image shooting means capable of shooting an image of part of or the whole region containing character information desired to be retrieved or translated, input means for selecting the shot image and instructing processing, communication means for transmitting and receiving the shot image or accompanying information, image feature calculating means for calculating an image feature of the shot image, storage means for storing data containing a feature quantity of the whole region containing the character information desired to be retrieved or translated from the shot image as well as the character information, control means for comparing the feature quantity calculated by the image feature calculating means and the feature quantity stored in the storage means, to specify what location is represented by the shot image in the feature quantity stored in the storage means, image display means for displaying, when the character information stored in the storage means exists at the location specified by the control means, the shot image or an image in which the character information is superimposed on the shot image; information providing server means including communication means for receiving the shot image data from the camera-equipped mobile terminal means and transmitting data containing the feature quantity of the whole region containing the character information desired to be retrieved or translated, image feature calculating means for calculating the image feature of the image data of the shot image received by the communication means, information database means for previously registering the image feature of the entire region containing the character information desired to be retrieved or translated, image collating means for collating the image feature calculated by the image feature calculating means with part of or whole the image feature registered in the information database means to see what image in the information database is searched for, and control means for retrieving the data containing the feature quantity of the whole region containing the character information desired to be retrieved or translated stored in the information database and the character information based on a result of the collation by the image collating means, and network means for connecting the camera-equipped mobile terminal means and the information providing server means to each other.

According to the present invention, character information can be converted and displayed as character information that is legible to the user shooting the image by: shooting an image of an installed signboard by the camera-equipped mobile terminal; transmitting image data of the shot part to the information providing server via the network; collating the image data with registered image data in the information database; transmitting an image feature extracting method for specifying the image data in the information database and specifying where the character information in the installed signboard is written together with image feature information and character information corresponding to the feature information to the camera-equipped mobile terminal via the network; extracting a feature from the image data shot by the camera within the camera-equipped mobile terminal according to the image feature extracting method; furthermore, specifying what location in the signboard the transmitted image feature information is shot from the image feature information; and specifying the character location of the character information contained in the screen.

Further, it goes without saying that the present invention is not limited to the embodiments described above, and various changes can be made within the range not departing from the above-described gist of the present invention. For example, in the present embodiment, though the present invention has been described as a hardware configuration, the present invention is not limited thereto. According to the present invention, it is also possible to realize any process by allowing a CPU (Central Processing Unit) to execute a computer program.

In such an example, the program can be stored using various types of non-transitory computer readable media (non-transitory computer readable media) and supplied to a computer. The non-transitory computer readable media include various types of tangible storage media (tangible storage media). Exemplary non-transitory computer readable media include magnetic recording media (for example, flexible disks, magnetic tapes, hard disk drives), magneto-optical recording media (for example, magneto-optical discs), CD-ROMs (Read Only Memories), CD-Rs, CD-R/Ws, DVDs (Digital Versatile Discs), BDs (Blu-ray (registered trademark) Discs), semiconductor memories (for example, mask ROMs, PROMs (Programmable RQMs), EPROMs (Erasable PROMs), flash ROMs, RAMs (Random Access Memories)). Further, the program may be supplied to a computer by various types of transitory computer readable media (transitory computer readable media). Exemplary transitory computer readable media include electric signals, optical signals, and electromagnetic waves. The transitory computer readable medium can supply such a program to a computer via wired communication path such as an electrical wire and an optical fiber, or via a wireless communication path.

Part of or all the foregoing embodiments can be described as in the following appendixes, but the present invention is not limited thereto.

(Supplementary Note 1)

A shot image processing system comprising:

a mobile terminal that shoots an image of a conversion target region containing a character and/or an image, and displays the shot image containing the conversion target region on display unit; and

a server that receives the shot image from the mobile terminal, wherein

the server determines a specifying method for specifying a location of the conversion target region in the received shot image, and transmits the determined specifying method to the mobile terminal, and

the mobile terminal specifies the location of the conversion target region in the shot image based on the specifying method received from the server, converts the conversion target region specified in the shot image into a prescribed format, and displays a converted image obtained by the conversion on the display unit.

(Supplementary Note 2)

The shot image processing system according to Supplementary Note 1, wherein

the server determines a method for calculating a feature quantity of the conversion target region as the specifying method, and

the mobile terminal calculates the feature quantity in the shot image using the feature quantity calculation method, and specifies the location of the conversion target region in the shot image based on a result of the calculation.

(Supplementary Note 3)

The shot image processing system according to Supplementary Note 1 or 2, wherein

the shot image is an image of a partial region of a whole region,

the mobile terminal further reshoots an image of other region of the whole region, and uses, in specifying a display region of the character information of the reshot image, a specifying method identical to the method used for the partial region.

(Supplementary Note 4)

The shot image processing system according any one of Supplementary Notes 1 to 3, wherein

the server further includes storage unit for previously storing a plurality of pieces of whole image information on a plurality of the whole regions, respectively,

the server calculates a feature quantity of the received shot image, refers to the storage unit to select whole image information corresponding to the shot image out of the plurality of pieces of whole image information, based on the calculated feature quantity, and determines the specifying method in accordance with the selected whole image information.

(Supplementary Note 5)

The shot image processing system according to Supplementary Note 4, wherein

in the server, the storage unit further stores, as to the conversion target region contained in each of pieces of the whole image information, location information of the conversion target region in the whole image information,

the server transmits the selected whole image information and the location information of the conversion target region contained in the whole image information to the mobile terminal together with the determined specifying method,

the mobile terminal specifies a region of the shot image located in the whole image information received from the server, based on the specifying method, and specifies the location of the conversion target region in the shot image, using the received location information contained in the region of the specified shot image.

(Supplementary Note 6)

The shot image processing system according to Supplementary Note 4 or 5, wherein

the storage unit stores location information indicative of locations of the plurality of whole regions and the pieces of whole image information as being associated with each other,

the mobile terminal acquires location information indicative of a location of the mobile terminal,

the mobile terminal adds the acquired location information to the shot image and transmits the acquired location information and the shot image to the server, and

the server refers to the storage unit, and selects whole image information corresponding to the shot image based on the calculated feature quantity and the received location information.

(Supplementary Note 7)

The shot image processing system according to any one of Supplementary Notes 4 to 6, wherein

the storage unit further stores converted image corresponding to the conversion target region contained in each of pieces of the whole image information,

the server transmits a converted image corresponding to the conversion target region contained in the selected whole image information to the mobile terminal together with the determined specifying method, and

the mobile terminal uses the converted image received from the server in converting the conversion target region into a prescribed format.

(Supplementary Note 8)

The shot image processing system according to Supplementary Note 7, wherein

the storage unit stores the converted image for each of a plurality of language types,

the mobile terminal adds a language type of the operator of the mobile terminal to the shot image and transmits the shot image and the language type to the server, and

the server refers to the storage unit, and selects a converted image corresponding to the conversion target region contained in the specified whole image information, based on the received language type.

(Supplementary Note 9)

The shot image processing system according to Supplementary Note 7, wherein

the storage unit stores the converted image for each of a plurality of pieces of age information,

the mobile terminal adds age information of the operator of the mobile terminal to the shot image and transmits the shot image and the age information to the server, and

the server refers to the storage unit, and selects converted image corresponding to the conversion target region contained in the specified whole image information, based on the received age information.

(Supplementary Note 10)

A shot image processing method comprising:

shooting an image, by a mobile terminal, of a conversion target region containing a character and/or an image;

transmitting, by the mobile terminal, the shot image containing the conversion target region to a server;

determining, by the server, a specifying method for specifying a location of the conversion target region in the received shot image;

transmitting, by the server, the determined specifying method to the mobile terminal;

specifying, by the mobile terminal, the location of the conversion target region in the shot image based on the specifying method received from the server;

converting, by the mobile terminal, the conversion target region specified in the shot image into a prescribed format; and

displaying, by the mobile terminal, a converted image obtained by the conversion on the display unit.

(Supplementary Note 11)

A mobile terminal comprising:

image shooting unit for shooting an image of a conversion target region containing a character and/or an image;

transmission unit for transmitting the shot image containing the conversion target region to a server;

reception unit for receiving a specifying method for specifying a location of the conversion target region in the shot image from the server;

specifying unit for specifying the location of the conversion target region in the shot image based on the received the specifying method;

conversion unit for converting the conversion target region specified by the shot image into a prescribed format; and

display unit for displaying a converted image obtained by the conversion.

(Supplementary Note 12)

An information processing apparatus comprising:

reception unit for receiving, from a mobile terminal having shot an image of a conversion target region containing a character and/or an image, the shot image containing the conversion target region;

determining unit for determining a specifying method for specifying a location of the conversion target region in the received shot image; and

transmission unit for transmitting the determined specifying method to the mobile terminal for causing the mobile terminal to specify the location of the conversion target region in the shot image based on the determined specifying method, to convert the conversion target region specified in the shot image into a prescribed format, and to display the converted image obtained by the conversion on display means.

(Supplementary Note 13)

A control program for causing a mobile terminal to execute:

a process of shooting an image of a conversion target region containing a character and/or an image;

a process of transmitting the shot image containing the conversion target region to a server;

a process of receiving a specifying method for specifying a location of the conversion target region in the shot image from the server;

a process of specifying the location of the conversion target region in the shot image based on the received specifying method;

a process of converting the conversion target region in the shot image into a prescribed format; and

a process of displaying a converted image obtained by conversion on display unit.

(Supplementary Note 14)

A control program for causing a computer to perform:

a process of receiving, from a mobile terminal having shot an image of a conversion target region containing a character and/or an image, the shot image containing the conversion target region;

a process of determining a specifying method for specifying a location of the conversion target region in the received shot image; and

a process of transmitting the determined specifying method to the mobile terminal for causing for causing the mobile terminal to specify the location of the conversion target region in the shot image based on the determined specifying method, to convert the conversion target region specified in the shot image into a prescribed format, and to display the converted image obtained by the conversion on a display unit.

In the foregoing, while the description has been given of the present invention referring to the embodiments, the present invention is not limited thereby. Various changes that can be understood by those skilled in the art can be made to the configurations and details of the present invention within the scope of the invention.

The present application is based on and claims the benefit of priority from Japanese Patent Application No. 2011-093237, filed on Apr. 19, 2011, the entire contents of which are incorporated herein by reference.

### REFERENCE SIGNS LIST

100 shot image processing system
1 mobile terminal
11 image shooting unit
12 transmission unit
13 reception unit
14 specifying unit
15 conversion unit
16 display unit
2 server
21 reception unit
22 determining unit
23 transmission unit
200 shot image processing system
3 camera-equipped mobile information terminal
31 image shooting unit
32 input IF unit
33 location information acquiring unit
34 display unit
35 communication unit
36 storage unit
37 image feature calculating unit
38 control unit
4 information providing server
41 communication unit
42 image feature calculating unit
43 intra-image optimum image feature detecting unit
44 control unit
45 storage unit
46 image collating unit
47 information DB
5 network
6 map

1. A shot image processing system comprising:
a mobile terminal that shoots an image of a conversion target region containing a character and/or an image, and displays the shot image containing the conversion target region on display unit; and
a server that receives the shot image from the mobile terminal, wherein
the server determines a specifying method for specifying a location of the conversion target region in the received shot image, and transmits the determined specifying method to the mobile terminal, and
the mobile terminal specifies the location of the conversion target region in the shot image based on the specifying method received from the server, converts the conversion target region specified in the shot image into a prescribed format, and displays a converted image obtained by the conversion on the display unit.

2. The shot image processing system according to claim 1, wherein
the server determines a method for calculating a feature quantity of the conversion target region as the specifying method, and
the mobile terminal calculates the feature quantity in the shot image using the feature quantity calculation method, and specifies the location of the conversion target region in the shot image based on a result of the calculation.

3. The shot image processing system according to claim 1, wherein
the shot image is an image of a partial region of a whole region,
the mobile terminal further reshoots an image of other region of the whole region, and uses, in specifying a display region of the character information of the reshot image, a specifying method identical to the method used for the partial region.

4. The shot image processing system according claim 1, wherein
the server further includes storage unit for previously storing a plurality of pieces of whole image information on a plurality of the whole regions, respectively,
the server calculates a feature quantity of the received shot image, refers to the storage unit to select whole image information corresponding to the shot image out of the plurality of pieces of whole image information, based on the calculated feature quantity, and determines the specifying method in accordance with the selected whole image information.

5. The shot image processing system according to claim 4, wherein
the storage unit further stores, as to the conversion target region contained in each of pieces of the whole image information, location information of the conversion target region in the whole image information,
the server transmits the selected whole image information and the location information of the conversion target region contained in the whole image information to the mobile terminal together with the determined specifying method,
the mobile terminal specifies a region of the shot image located in the whole image information received from the server, based on the specifying method, and specifies the location of the conversion target region in the shot image, using the received location information contained in the region of the specified shot image.

6. A shot image processing method comprising:
shooting an image, by a mobile terminal, of a conversion target region containing a character and/or an image;
transmitting, by the mobile terminal, the shot image containing the conversion target region to a server;
determining, by the server, a specifying method for specifying a location of the conversion target region in the received shot image;
transmitting, by the server, the determined specifying method to the mobile terminal;
specifying, by the mobile terminal, the location of the conversion target region in the shot image based on the specifying method received from the server;
converting, by the mobile terminal, the conversion target region specified in the shot image into a prescribed format; and
displaying, by the mobile terminal, a converted image obtained by the conversion on a display unit.

7. A mobile terminal comprising:
image shooting unit for shooting an image of a conversion target region containing a character and/or an image;
transmission unit for transmitting the shot image containing the conversion target region to a server;
reception unit for receiving a specifying method for specifying a location of the conversion target region in the shot image from the server;
specifying unit for specifying the location of the conversion target region in the shot image based on the received the specifying method;
conversion unit for converting the conversion target region specified by the shot image into a prescribed format; and
display unit for displaying a converted image obtained by the conversion.

8. An information processing apparatus comprising:
reception unit for receiving, from a mobile terminal having shot an image of a conversion target region containing a character and/or an image, the shot image containing the conversion target region;
determining unit for determining a specifying method for specifying a location of the conversion target region in the received shot image; and
transmission unit for transmitting the determined specifying method to the mobile terminal for causing the mobile terminal to specify the location of the conversion target region in the shot image based on the determined specifying method, to convert the conversion target region specified in the shot image into a prescribed format, and to display the converted image obtained by the conversion on display unit.

9. A non-transitory computer readable medium that stores a control program for causing a mobile terminal to execute:
a process of shooting an image of a conversion target region containing a character and/or an image;
a process of transmitting the shot image containing the conversion target region to a server;
a process of receiving a specifying method for specifying a location of the conversion target region in the shot image from the server;
a process of specifying the location of the conversion target region in the shot image based on the received specifying method;
a process of converting the conversion target region in the shot image into a prescribed format; and
a process of displaying a converted image obtained by conversion on display unit.

10. A non-transitory computer readable medium that stores a control program for causing a computer to perform:
a process of receiving, from a mobile terminal having shot an image of a conversion target region containing a character and/or an image, the shot image containing the conversion target region;
a process of determining a specifying method for specifying a location of the conversion target region in the received shot image; and
a process of transmitting the determined specifying method to the mobile terminal for causing for causing the mobile terminal to specify the location of the conversion target region in the shot image based on the determined specifying method, to convert the conversion target region specified in the shot image into a prescribed format, and to display the converted image obtained by the conversion on a display unit.

11. The shot image processing system according to claim 4, wherein
the storage unit stores location information indicative of locations of the plurality of whole regions and the pieces of whole image information as being associated with each other,
the mobile terminal acquires location information indicative of a location of the mobile terminal,
the mobile terminal adds the acquired location information to the shot image and transmits the acquired location information and the shot image to the server, and
the server refers to the storage unit, and selects whole image information corresponding to the shot image based on the calculated feature quantity and the received location information.

12. The shot image processing system according to claim 4, wherein
the storage unit further stores converted image corresponding to the conversion target region contained in each of pieces of the whole image information,
the server transmits a converted image corresponding to the conversion target region contained in the selected whole image information to the mobile terminal together with the determined specifying method, and
the mobile terminal uses the converted image received from the server in converting the conversion target region into a prescribed format.

13. The shot image processing system according to claim 12, wherein
the storage unit stores the converted image for each of a plurality of language types,
the mobile terminal adds a language type of the operator of the mobile terminal to the shot image and transmits the shot image and the language type to the server, and
the server refers to the storage unit, and selects a converted image corresponding to the conversion target region contained in the specified whole image information, based on the received language type.

14. The shot image processing system according to claim 12, wherein
the storage unit stores the converted image for each of a plurality of pieces of age information,
the mobile terminal adds age information of the operator of the mobile terminal to the shot image and transmits the shot image and the age information to the server, and
the server refers to the storage unit, and selects converted image corresponding to the conversion target region contained in the specified whole image information, based on the received age information.

15. A shot image processing system comprising:
a mobile terminal that shoots an image of a conversion target region containing a character and/or an image, and displays the shot image containing the conversion target region on display means; and
a server that receives the shot image from the mobile terminal, wherein
the server determines a specifying method for specifying a location of the conversion target region in the received shot image, and transmits the determined specifying method to the mobile terminal, and
the mobile terminal specifies the location of the conversion target region in the shot image based on the specifying method received from the server, converts the conversion target region specified in the shot image into a prescribed format, and displays a converted image obtained by the conversion on the display means.

16. A mobile terminal comprising:
image shooting means for shooting an image of a conversion target region containing a character and/or an image;
transmission means for transmitting the shot image containing the conversion target region to a server;
reception means for receiving a specifying method for specifying a location of the conversion target region in the shot image from the server;
specifying means for specifying the location of the conversion target region in the shot image based on the received the specifying method;
conversion means for converting the conversion target region specified by the shot image into a prescribed format; and
display means for displaying a converted image obtained by the conversion.

17. An information processing apparatus comprising:
reception means for receiving, from a mobile terminal having shot an image of a conversion target region containing a character and/or an image, the shot image containing the conversion target region;
determining means for determining a specifying method for specifying a location of the conversion target region in the received shot image; and
transmission means for transmitting the determined specifying method to the mobile terminal for causing the mobile terminal to specify the location of the conversion target region in the shot image based on the determined specifying method, to convert the conversion target region specified in the shot image into a prescribed format, and to display the converted image obtained by the conversion on display means.
